(19) United States
(12) Patent Application Publication
(10) Pub. No.: US 2006/0160499 A1
(43) Pub. Date: Jul. 20, 2006

(54) Polar modulator and method for modulation of a signal

(76) Inventor: Giuseppe Li Puma, Bochum (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/294,010

(22) Filed: Dec. 5, 2005

(30) Foreign Application Priority Data
Dec. 14, 2004 (DE) DE 102004060177.1

(51) Int. Cl. H04B 1/04; H01Q 11/12

(52) U.S. Cl. 455/116

(57) ABSTRACT

A modulated carrier signal is produced from a phase modulation signal in a phase locked loop in a polar modulator. This carrier signal is converted via a limiting amplifier to a square-wave signal, which is supplied to an amplifier. At the same time, an amplitude modulation signal at one input is connected to a control input of a controllable current source. The controllable current source is designed to emit a supply current at a current output as a function of the amplitude modulation signal at the control input. The current output of the controllable current source is connected to a supply input of the amplifier. The supply current for the amplifier is thus modulated on the basis of the amplitude information to be transmitted. The processing of the amplitude information within the current domain makes it possible to produce the polar modulator according to the invention as an integrated circuit, using CMOS technology.

### REFERENCE TO RELATED APPLICATIONS

This application claims the benefit of the priority date of German application DE 10 2004 060 177.1, filed on Dec. 14, 2004, the contents of which are herein incorporated by reference in their entirety.

### FIELD OF THE INVENTION

One or more aspects or embodiments of the present invention relate to a polar modulator, and to a method for modulation of a signal.

### BACKGROUND OF THE INVENTION

In modern communications systems, the information to be transmitted can be coded in phase and amplitude of a signal. This allows considerably greater data transmission rates to be achieved than with a pure amplitude modulation or phase modulation. Examples of modulation types such as these are PSK modulation (phase shift keying). These include, inter alia, π/4 DQPSK, 8-DPSK or 8-PSK modulation. Quadrature amplitude modulation (QAM) also codes both the amplitude and the phase of the information to be transmitted. In contrast to analog amplitude or frequency modulation, the stated types of modulation are referred to as digital modulation types.

FIG. 7 shows a so-called constellation diagram for QPSK modulation. The abscissa in this case represents a first component, which is referred to as the real component I. The ordinate forms the second, quadrature component Q. The information to be transmitted is coded by a value pair i, q, depending on its content, at one of the illustrated points. A value pair i, q such as this is referred to as a symbol. In the illustrated exemplary embodiment, one such symbol in the QPSK modulation type that is used codes a total of two bits of data content, specifically the bits 00, 01, 10 or 11. The amplitudes and the phase of the I and Q values change over time depending on the information to be transmitted. The amplitude of the overall signal is thus also changed. In consequence, QPSK modulation is referred to as a modulation type with a non-constant envelope (non-constant envelope modulation). The QPSK modulation type is used, for example, for the WCDMA/UMTS mobile radio standard.

In addition to representing a symbol by a value pair i, q, it is possible to define the phase p and the amplitude r of the same symbol. The symbol which represents the data content 00 is illustrated in a corresponding form in the exemplary embodiment shown in FIG. 7. The two representations using IQ notation or rφ notation are equivalent.

In addition to I/Q modulators, polar modulators can also be used to transmit modulated signals. While I/Q modulators process i, q value pairs for modulation of a signal, polar modulators modulate the phase p and the amplitude r. FIG. 5 shows one embodiment of a known I/Q modulator. In this embodiment, the components I, Q are supplied as digital signals in each case to a digital/analog converter 99, which converts them to analog components which it supplies via a low-pass filter 991 to the inputs of two mixers 992. The two mixers are supplied as a local oscillator signal with signals which have a phase offset of 90° with respect to one another. After frequency conversion by the two mixers, the two signals are added, and are amplified in a power amplifier PA.

FIG. 6 shows one example of a known polar modulator. The information to be transmitted is in the form of digital data and is preprocessed in a coder circuit 393 to form amplitude information r and phase information φ. This is supplied to a pulse form circuit 301, where it is preprocessed. The preprocessed data then has its phase value φ(k) and its amplitude value r(k) converted in the circuit 302. The phase information φ(k) is supplied to a phase locked loop PLL and is used to modulate the output signal from the phase locked loop on the basis of the information coded in the phase. A phase-modulated output signal φ(t) which varies over time is thus produced at the output of the phase locked loop PLL. At the same time, the amplitude information r(k) is applied to a digital/analog converter DAC, which converts the digital amplitude information r(k) to an analog signal r(t) in the time domain. The analog amplitude modulation signal r(t) is supplied to a mixer via a low-pass filter. The phase-modulated signal is combined with the amplitude modulation signal in this mixer.

The requirements for the last mixer stage can present a problem in some situations. This mixer stage should have a highly linear transfer function sufficient to provide a wide amplitude range required in many mobile radio standards. If the mixer has a non-linear transfer function, amplitude or phase distortion can occur depending on the amplitude modulation signal r(t). This type of distortion is referred to as AM/AM or AM/PM distortion. The distortion produces data errors, and changes the frequency spectrum of the emitted signal. In addition, mixers require a large amount of current to satisfy the linearity requirements.

The embodiment illustrated in FIG. 6 also leads to the mixer occupying a large amount of space. Furthermore, a polar modulator such as this cannot be implemented using novel CMOS technology with low supply voltages in the range from 1.5 V to 2.5 V.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

One or more aspects or embodiments of the present invention pertain to providing a polar modulator which is suitable for low supply voltages and can be produced in a space-saving form, preferably as an integrated circuit in a semiconductor body, as well as to providing a method for modulation of a signal which can be implemented with a low current draw.

According to one or more aspects or embodiments of the present invention, a polar modulator has a first signal input for supplying a phase modulation signal and a second signal input for supplying an amplitude modulation signal. A phase locked loop with a reference input for supplying a reference signal is coupled by a control input to the first signal input. The control loop is designed to emit a radio-frequency signal at a frequency which is derived from the reference signal and the phase modulation signal at the control input of the control loop. Furthermore, a controllable current source is provided and is connected by a regulation input to the second signal input. The current source is designed to emit at one output a current which is dependent on the amplitude modulation signal at the regulation input. An amplifier is connected to an output of the phase locked loop by means of a signal input for supplying a signal that is to be amplified. A signal output of the amplifier forms an output of the polar modulator. Furthermore, the amplifier has a supply connection for supplying a supply current for operation of the amplifier, and this is connected to the output of the controllable current source.

According to one or more aspects or embodiments of the present invention, the polar modulator is produced in a semiconductor body, in particular using CMOS technology. Amplitude modulation is preferably carried out in the polar modulator by modulation of the supply current for the amplifier which is connected downstream from the phase locked loop. This makes it possible to achieve a particularly high dynamic range, since the signal-to-noise ratio that can be achieved is considerably greater when the supply current is modulated than with comparable modulation of a voltage signal. In particular, this makes it possible to produce the modulator using CMOS technology in an integrated semiconductor body.

According to one or more aspects or embodiments of the present invention, an amplifier circuit which has a limiting gain response is provided between the output of the phase locked loop and the signal input of the amplifier. The amplifier may also be a differential amplifier and may contain a first transistor as well as a second transistor. The control connections of the two transistors form the signal input of the amplifier. A first connection of the first and of the second transistor are in each case connected to one another at a node which forms the supply connection for the current supply. This amplifier can be operated in a switching operating mode. This is achieved by means of an amplifier, which may be connected upstream, with a limiting gain response.

According to one or more aspects or embodiments of the present invention, the amplifier contains a transformer which is designed to transform a push-pull output signal to a single-ended output signal. A matching network is preferably connected to the transformer, for impedance transformation.

According to one or more aspects or embodiments of the present invention, the phase locked loop, which may have a frequency divider in a feedback path, is designed to divide the frequency of a signal which is applied to its input side by a variable division factor. The setting input of the frequency divider may be preceded by a sigma-delta frequency divider, whose input side is coupled to the first signal input. The upstream sigma-delta modulator makes it possible to set different frequency division ratios and, in particular, fractional frequency division ratios. This allows the phase of the output signal of the phase locked loop to be modulated very efficiently.

According to one or more aspects or embodiments of the present invention, the phase locked loop has a two-point modulator. This is distinguished in that the setting input is coupled not only to an additional control input of the voltage controlled oscillator in the phase locked loop but also to the frequency divider circuit. In the case of a two-point modulator not only is the frequency division ratio thus reset, but the voltage controlled oscillator in the control loop is also directly modulated.

According to one or more aspects or embodiments of the present invention, a controllable current source contains a current mirror. One output of the current mirror transistor in the controllable current source forms the output of the current source. A first transistor can be supplied with a reference current which is derived from the amplitude modulation signal. The controllable current source can contain a digital/analog converter, whose input is connected to the control input and which, on the input side, converts a discrete-value signal supplied to it to a current signal at an output. A low-pass filter can be connected between the digital/analog converter and the output of the controllable current source. This suppresses high-value frequency components which are produced during a conversion process.

According to one or more aspects or embodiments of the present invention, the controllable current source contains a large number of current source elements, whose outputs can be connected to the output of the current source via in each case one switching apparatus which can be controlled by a signal at the control input. The large number of current source elements are preferably designed using current mirrors.

According to one or more aspects or embodiments of the present invention, a method for modulation of a signal includes providing a phase locked loop with a variable frequency division ratio in a feedback path of the phase locked loop, providing an amplifier and coupling the amplifier to the phase locked loop, providing phase information and amplitude information for signal modulation, supplying the phase information to the phase locked loop, and setting of the frequency division ratio as a function of the phase information, producing a phase-modulated signal as a function of the selected frequency division ratio, producing a current signal from the amplitude information and supplying the phase-modulated signal to the amplifier, with the amplifier simultaneously being supplied with a supply current which is derived from the current signal.

According to one or more aspects or embodiments of the present invention, both the phase and the amplitude of a signal are modulated, with amplitude modulation being carried out by modulation of a supply current for an amplifier. The modulation of a supply current makes it possible to reduce the supply voltage in order to use the method in a preferred manner in integrated circuits in a semiconductor body. At the same time, however, this allows the signal-to-noise ratio of the supply current to be as desired. The amplitude modulation of the supply current likewise allows additional functions to be achieved, such as power ramping or setting of a maximum output power, particularly easily and cost-effectively. Pure frequency modulation can likewise be achieved by supplying a constant amplitude modulation signal.

### BRIEF DESCRIPTION OF THE DRAWINGS

The invention is explained in more detail below wherein reference is made to the following drawings.

FIG. 1 is a schematic block diagram illustrating an exemplary circuit arrangement according to one or more aspects or embodiments of the present invention.

FIG. 2 is a schematic block diagram illustrating an exemplary circuit arrangement according to one or more aspects or embodiments of the present invention.

FIG. 3 is a schematic block diagram illustrating an exemplary circuit arrangement according to one or more aspects or embodiments of the present invention.

FIG. 4 is a schematic illustration of an example of a current mirror.

FIG. 5 is a schematic illustration of an example of an I/Q modulator.

FIG. 6 is a schematic illustration of an example of a polar modulator.

FIG. 7 illustrates a constellation diagram representing information to be transmitted.

### DETAILED DESCRIPTION OF THE INVENTION

One or more aspects or embodiments of the present invention will now be described with reference to the drawing figures, wherein like reference numerals are used to refer to like elements throughout. It should be understood that the drawing figures and following descriptions are merely illustrative and that they should not be taken in a limiting sense. In the following description, for purposes of explanation, numerous specific details are set forth in order to provide a thorough understanding. It will be appreciated that variations of the illustrated systems and methods apart from those illustrated and described herein may exist and that such variations are deemed as falling within the scope of the present invention and the appended claims.

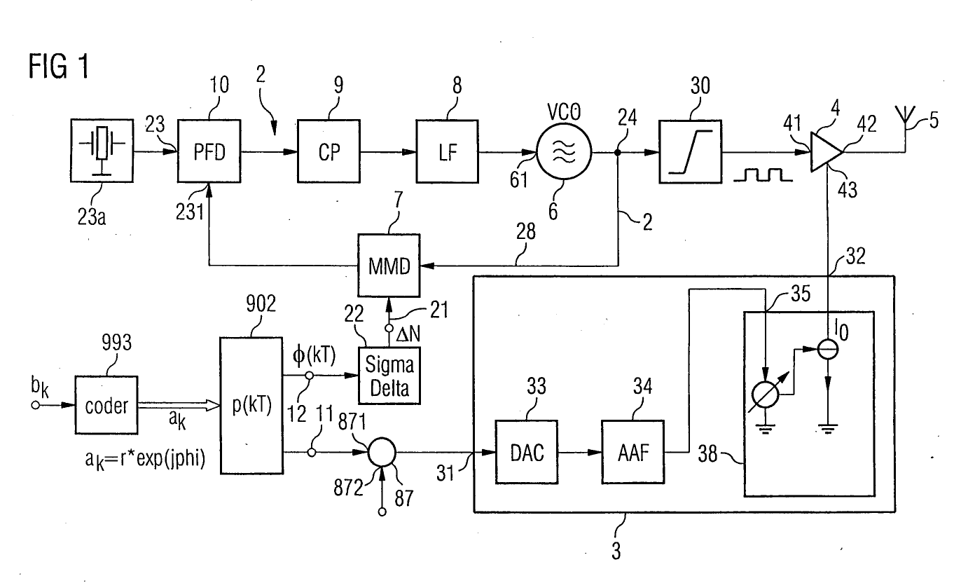

Turning to FIG. 1, a polar modulator according to one or more aspects of embodiments of the present invention is illustrated where the modulator is formed in a semiconductor body using CMOS technology. By way of example, silicon, gallium arsenide or silicon-germanium (SiGe) may be used as the semiconductor material. The polar modulator is formed as an integrated circuit in this semiconductor material using CMOS technology. Increasing miniaturization makes it necessary to reduce the supply voltage for the switching elements, as well. Control voltages are likewise reduced. In the process, however, the signal-to-noise ratio of the signals may be degraded. The reduction means that it may not be possible to comply with the linearity requirements for mixers which may be present in the polar modulator.

Accordingly, instead of frequency mixers, the polar modulator disclosed herein uses an amplifier whose supply current is modulated in order to achieve amplitude modulation. The output stage could thus be referred to as a “power mixer”, which converts the amplitude component to the phase-modulated carrier signal.

The polar modulator has a first input 12 which is designed to supply a phase information signal φ(kT). This is supplied to the polar modulator as a digital signal. Furthermore, it has a second input 11, to which the amplitude information is applied, in the form of a digital signal r(kT).

The polar modulator contains a phase locked loop 2. This has a phase detector 10 with a reference input 23 as well as a feedback input 231. The reference input 23 is connected to a reference signal generator 23a in order to produce a signal at a reference frequency. This may, for example, be a crystal with a particularly stable resonant frequency. The phase detector 10 compares the phases of the signals applied to the inputs 23 and 231 and uses this comparison to produce a control signal, which it emits to a charge pump 9. The charge pump 9 is connected via a loop filter 8 to a control input 61 of a voltage controlled oscillator 6. The control signal is used to set the frequency of an output signal from the voltage controlled oscillator 6. The voltage controlled oscillator 6 emits this signal at its output.

The output of the voltage controlled oscillator is connected to a feedback path 28 at a node 24. A frequency divider circuit 7 is provided in this feedback path 28, which divides the frequency of any signal which is applied to its input side by a variable division factor, and supplies the frequency-divided signal to the feedback input 231 of the phase detector 10. The frequency division ratio can be set at the control input 21 of the frequency divider circuit 7. The frequency of the output signal from the control loop is thus changed as a function of any change to that frequency division ratio. The output signal from the phase locked loop can thus be phase-modulated and/or frequency-modulated.

The control input 21 of the frequency divider 7 is connected to a sigma-delta modulator 22, whose input side is connected to the first signal input 12 in order to supply the phase modulation signal. The sigma-delta modulator uses the phase information, represented by the phase modulation signal φ(kT), to produce a frequency adjustment ratio, which comprises an integer value N and a fractional division value ΔN. The sigma-delta modulator 22 supplies the frequency adjustment ratio to the control input 21, and thus to the frequency divider 7, for frequency-modulation and/or phase-modulation of the output signal in the phase locked loop.

The output of the phase locked loop is connected to a limiting amplifier 30, which uses the output signal from the phase locked loop to produce an essentially square-wave signal. In this case, the phase information is retained in the zero crossing of the square-wave signal. The square-wave signal is applied to one input 41 of an amplifier 4. The output of the amplifier 4 is connected to an antenna 5.

The amplitude modulation signal r(kT) which is applied to the input 11 is converted to a current signal, which is supplied as a supply current to the amplifier 4. For this purpose, the input 11 is connected to a first input 871 of a multiplication unit 87. The multiplication unit 87 scales the amplitude modulation signal by a scaling factor which is supplied to a second input 872. The scaling factor is used to adjust the overall amplitude, and thus the overall power. If, by way of example, the output power from the polar modulator is intended to rise by 3 dB, then it is expedient to change the output power by scaling of the amplitude modulation signal.

The scaled amplitude information is used to adjust the supply current to a controllable current source 3. The controllable current source 3 contains a digital/analog converter 33, which uses the digital and discrete-value amplitude modulation signal to produce an analog amplitude modulation signal which is supplied via an anti-aliasing filter 34 to a control input 35. The anti-aliasing filter 34 suppresses the higher-value components in the analog amplitude modulation signal, which are produced during the digital/analog conversion process. The control input 35 is coupled to the output 32 of the controllable current source 3.

The current signal which is applied to the input 35 controls the supply current at the output 32, and thus the supply current for the amplifier 4. The amplitude information is thus converted to modulation of the supply current for the amplifier 4. The modulation of the supply current means that a sufficiently good signal-to-noise ratio is maintained at the same time, and the supply voltage for the amplifier 4 can be matched to the manufacturing technology being used, in a suitable manner.

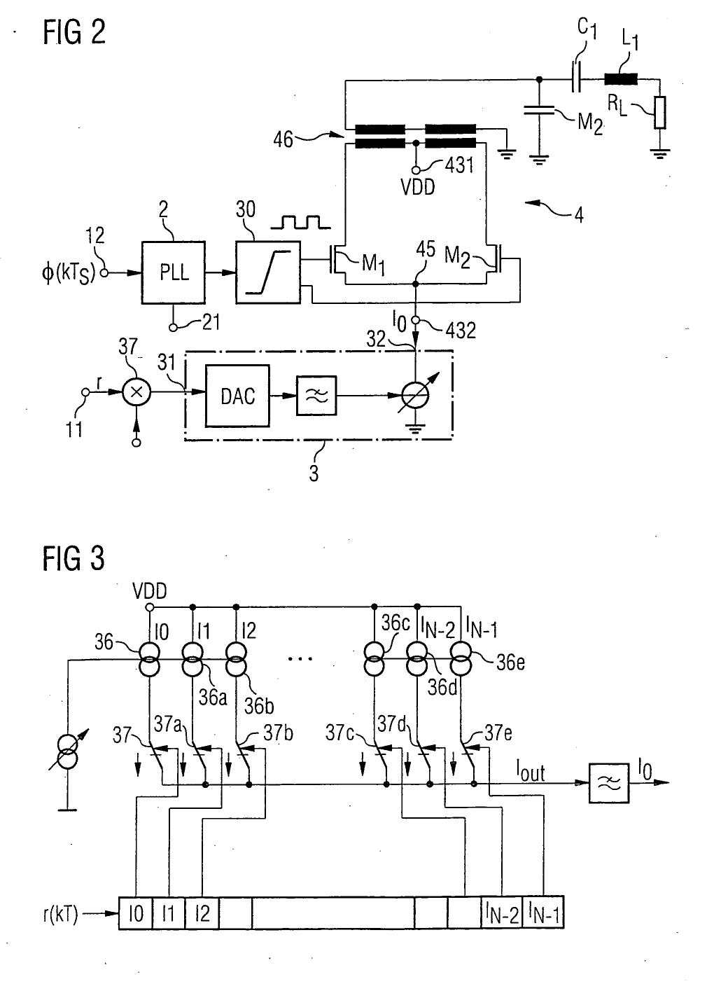

FIG. 2 illustrates an example of the amplifier 4, together with further elements of the polar modulator according to one or more aspects or embodiments of the present invention. The same or similar components bear the same reference characters. The input 12 for supplying the phase information signal φ(kt) is also connected in this case to the phase locked loop 2, whose output side is coupled to the amplifier 4 via the limiting amplifier 30. The amplifier 4 is in the form of a differential amplifier with two differential amplifier transistors M₁ and M₂. In this case, the control connections of the two differential amplifier transistors M₁ and M₂ are connected to the output of the limiting amplifier 30. This has applicability to push-pull signals.

The two differential amplifier transistors M₁ and M₂ are connected to one another by a first connection at a common node 45. This node 45 leads to a first supply connection element 432, which is connected directly to the output 32 of the controllable current source 3. The respective second connections of the field-effect transistors M₁ and M₂ are connected to one another via a part of a transformer 46.

The transformer 46 contains a supply connection element 431 for supplying a potential V_{DD}. Furthermore, the transformer 46 is connected to a matching network from the capacitor C1 and the coil L1 connected in series. A second capacitor C2 is provided in parallel with this. The matching network is used for impedance matching of the impedances of the transformer 46 to an externally connected load R_{L}. The load, which is illustrated schematically here, is preferably in the form of an antenna.

During operation, an amplitude information signal r(kT) and a phase modulation signal φ(kT) are supplied to the inputs 11 and 12 of the polar modulator according to the invention. The two signals r(kT) and φ(kT) are produced by the coder circuit 993 and the circuit 902 from discrete-value coefficients aₖ. The phase modulation signal φ(kT) is processed in the phase locked loop. The phase locked loop 2 produces a phase-modulated and/or frequency-modulated output signal, and supplies this to the limiting amplifier 30, which uses it to produce a square-wave signal. At the same time as the phase information signal, the amplitude information signal has a scaling factor applied to it by the multiplication unit 87. The scaling factor is in this case governed by the desired overall output power.

The amplitude modulation signal that has been scaled in this way is then converted in a digital/analog converter in the current source 3 to a correspondingly amplitude-modulated current signal. The downstream low-pass filter is used to suppress relatively high-frequency components which are produced during the digital/analog conversion process. It is expedient to provide signal processing and, in particular, digital/analog conversion in the form of pure current signal processing. This makes it possible to achieve a desirable signal-to-noise ratio in a suitable manner with low supply voltages. A higher-order anti-aliasing filter may be used as the low-pass filter. It is likewise possible to supply the current signal to a current/voltage converter within the filter device and to carry out a filtering process in the voltage domain. The filtered voltage signal is then once again converted to a current signal.

FIG. 3 illustrates an example of a digital/analog converter which operates in the current domain and emits an analog current signal Iₒᵤₜ. The converter illustrated in FIG. 3 is part of the controllable current source and has a plurality of current source elements 36, 36a, 36b, 36c to 36e which are arranged in parallel and each produce a fixed current I0, I1, I2, . . . , IN-2, IN-1. On the output side, the current sources 36, 36a to 36e are connected to switching apparatuses 37, 37a to 37e. These connect the respective current sources to the output of the digital/analog converter as a function of the amplitude modulation signal.

In the illustrated example, the digital amplitude modulation signal is oversampled. Oversampling of a digital signal allows considerably finer resolution and thus better quantization. By way of example, the oversampling frequency is 26 MHz for a baseband signal frequency of 270.83 kHz. The amplitude modulation signal r(kT) is thus 96-times oversampled. The illustrated digital/analog converter accordingly contains 96 current source elements 36 arranged in parallel.

The current which is produced by the current source elements may be different for each current source element. As an alternative to this, each current source element emits the same current. An embodiment such as this has the advantage that it is possible to compensate better for systematic errors and errors resulting from component fluctuations.

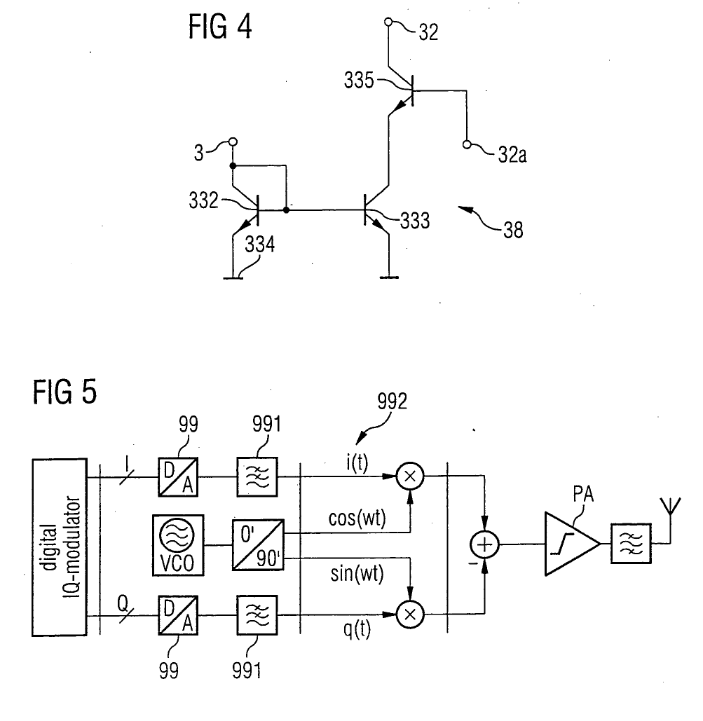

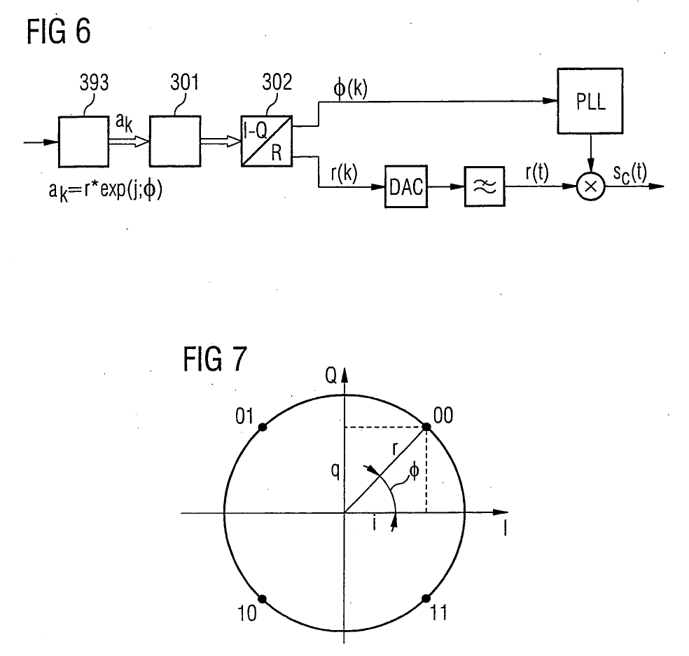

A current source element may be in the form of a simple current mirror. A current mirror such as this is illustrated, by way of example, in FIG. 4, which is an example of circuit block 35. The current mirror shown in FIG. 4 uses bipolar transistors and a cascode bipolar transistor. The current mirror contains a first transistor 332, whose control connection is connected to his collector connection and therefore to the control input 35. The emitter connection of the transistor 332 is connected to ground. A current mirror transistor 333 is also provided, whose control connection is connected to the control connection of the first transistor 332, and whose collector is connected to the emitter of a cascode transistor 335. The collector of the cascode transistor forms the output 32 of the circuit block 38. This current mirror mirrors a current signal that is applied to the input 35 at the output 32. The output current at the output 32 is thus also modulated by modulation of a current signal which is applied to the input 3.

The current mirror ratio can be varied by the choice of different geometry parameters in the transistors 332 and 333. Furthermore, it is possible to arrange a plurality of current mirror transistors 333 in parallel to increase the output current as a function of the desired output power. The embodiment illustrated here uses bipolar transistors. Field-effect transistors can likewise be implemented.

The invention thus provides a polar modulator which can be produced as an integrated circuit in a semiconductor body. The need for a mixer for modulation of the signal is eliminated. The amplitude modulation is carried out by modulation of the supply current for an amplifier which is connected downstream from the phase modulator. This results in a desired signal-to-noise ratio despite low supply voltages.

### LIST OF REFERENCES SYMBOLS

2: Phase locked loop

3: Controllable current source

4: Amplifier

6: Voltage controlled oscillator

7: Frequency divider

8: Loop filter

9: Charge pump

10: Phase detector

11: Amplitude information input

12: Phase information input

5: Antenna

21: Control input

22: Sigma-delta modulator

23: Reference input

23a: Reference signal generator

231: Feedback input

24: Node

61: Control input

41: Signal input

30: Limiting amplifier

42: Signal output

43: Current supply input

32: Current supply output

33: Digital/analog converter

34: Low-pass filter

38: Circuit block, current mirror

35: Control input

36, 36a, . . . , 36e: Current source elements

37, 37a, . . . , 37e: Switches

31: Control input

87: Multiplication unit

871, 872: Signal inputs

431, 432: Supply connection elements

46: Transformer

C1, C2: Capacitors

L1: Coil

M₁, M₂: Transistors

1. A polar modulator, comprising:
a first signal input for supplying a phase modulation signal (φ) and a second signal input for supplying an amplitude modulation signal (r);
a phase locked loop with a reference input for supplying a reference signal and with a control input which is coupled to the first signal input, the phase locked loop designed to emit a radio-frequency signal at one frequency at one output, with the frequency being derived from the reference signal and the phase modulation signal (φ) at the control input of the phase locked loop;
a controllable current source with a regulation input which is coupled to the second signal input, the current source designed to emit at one output a current which is dependent on the amplitude modulation signal (r) at the regulation input;
an amplifier with a signal input for supplying a signal which is to be amplified and is coupled to the output of the phase locked loop, with a signal output which forms an output of the polar modulator, and with a supply connection for supplying a supply current, which is connected to the output of the controllable current source.

2. The polar modulator of claim 1, further comprising:
an amplifier circuit which has a limiting gain response provided between the output of the phase locked loop and the signal input of the amplifier.

3. The polar modulator of claim 1, wherein the amplifier has a first connecting element designed to supply a supply potential (V_{DD}), and a second connecting element connected to the output of the controllable current source.

4. The polar modulator of claim 1, wherein the amplifier has a differential amplifier which has a first transistor (M₁) and a second transistor (M₂), with control connections of the transistors (M₁, M₂) forming the signal input of the amplifier, a first connection of the first and of the second transistor being connected to one another at a node which forms the supply connection.

5. The polar modulator of claim 1, wherein the amplifier is designed using field-effect transistors.

6. The polar modulator of claim 1, wherein the amplifier has a transformer which is designed to transform a push-pull signal to a single-ended signal.

7. The polar modulator of claim 1, wherein the phase locked loop has a frequency divider in a feedback path, which is designed to divide the frequency of a signal which is applied to its input side by a variable division factor, and which has a setting input which is connected to the first signal input in order to set the division factor.

8. The polar modulator of claim 7, wherein the setting input of the frequency divider is preceded by a sigma-delta frequency divider, whose input side is coupled to the first signal input.

9. The polar modulator of claim 1, wherein the phase locked loop has a two-point modulator.

10. The polar modulator of claim 1, wherein the controllable current source has a current mirror with a first and a second transistor which are coupled on the control side, with one output of the second transistor forming the output of the current source, where the first transistor can be supplied with a reference current which is derived from the amplitude modulation signal (r).

11. The polar modulator of claim 1, wherein the controllable current source has a digital/analog converter, whose input is connected to the control input and which converts a discrete-value signal, which is supplied to its input side, to a current signal.

12. The polar modulator of claim 11, wherein a low-pass filter is connected between the digital/analog converter and the output of the controllable current source.

13. The polar modulator of claim 1, wherein the controllable current source comprises a plurality of current source elements, whose outputs can be connected to the output of the controllable current source via a switching apparatus which can be controlled by a signal at the control input.

14. The polar modulator of claim 13, wherein at least one of the current source elements is designed to produce at least two variable current elements of different magnitude.

15. The polar modulator of claim 13, wherein a first current source element is designed to produce a current element (I0) which differs by a factor of two from a current element (I1) of a second current source element.

16. The polar modulator of claim 1, wherein the regulation input of the current source is preceded by a multiplication unit designed to scale the amplitude modulation signal at a first input of the multiplication unit by a scaling factor which can be supplied to a second input.

17. The polar modulator of claim 2, wherein the regulation input of the current source is preceded by a multiplication unit designed to scale the amplitude modulation signal at a first input of the multiplication unit by a scaling factor which can be supplied to a second input.

18. The polar modulator of claim 3, wherein the regulation input of the current source is preceded by a multiplication unit designed to scale the amplitude modulation signal at a first input of the multiplication unit by a scaling factor which can be supplied to a second input.

19. A method for modulation of a signal, comprising:
providing a phase locked loop with a variable frequency division ratio in a feedback path of the phase locked loop;
providing an amplifier and coupling the amplifier to the output of the phase locked loop;
providing a phase modulation signal (φ) and of an amplitude modulation signal (r) for signal modulation;
supplying the phase modulation signal (φ) to the phase locked loop and setting the frequency division ratio as a function of the phase modulation signal (φ);
producing a phase-modulated signal as a function of the selected frequency division ratio;
producing a current signal from the amplitude modulation signal (r); and
supplying the phase-modulated signal to the amplifier, with the amplifier concurrently being supplied with a supply current which is derived from the current signal.

20. The method of claim 19, wherein producing a current signal comprises:
scaling the amplitude modulation signal by a factor; and
producing a continuous-value current signal from the scaled amplitude modulation signal.
